(19) United States
(12) Patent Application Publication
(10) Pub. No.: US 2011/0291805 A1
(43) Pub. Date: Dec. 1, 2011

(54) PASSIVE RFID CHIP READER ANTENNA AND EMBEDDED RFID CHIPS

(76) Inventors: Christopher D. GELOWITZ, Wetaskiwin (CA); Chen Yuan LEE, Taichung (TW)

(21) Appl. No.: 13/083,373

(22) Filed: Apr. 8, 2011

Related U.S. Application Data
(60) Provisional application No. 61/348,575, filed on May 26, 2010.

(51) Int. Cl. H04Q 5/22

(52) U.S. Cl. 340/10.1

(57) ABSTRACT

The present disclosure teaches an RFID chip reader comprising two spaced-apart antennae in electrical communication with each other, with one antenna being incorporated into the chip reader, and with the other antenna separate from the main body of the chip reader but in electrical communication with the other antenna by suitable circuitry. The RFID chip reader may optionally include tuner means disposed within the circuitry connecting the two antennae. One antenna may be smaller than the other to facilitate reading of data from an RFID chip associated with an object made from a electrically-conductive material. The chip reader may optionally incorporate tuner means associated with the circuitry connecting the antennas, to optimize circuitry effectiveness.

Also taught is an RFID plug comprising an RFID chip encased within a non-conductive matrix, and having deformable projections to facilitate effectively permanent press-fit installation into a plug-receiving pocket in an object associated with the RFID chip.

### CROSS-REFERENCE TO RELATED APPLICATIONS

This application claims the benefit of U.S. Provisional Application No. 61/348,575, filed on May 26, 2010, and said earlier application is incorporated herein by reference in its entirety for continuity of disclosure.

### FIELD OF THE DISCLOSURE

The present disclosure relates in general to devices for reading passive RFID chips, and in particularly to devices for reading passive RFID chips that are embedded or encased in metallic articles. The disclosure further relates to RFID chips embedded or encapsulated in a protective matrix and adapted for insertion and secure retention within chip-receiving pockets in objects to be tracked with RFID technology, without requiring adhesives.

### BACKGROUND

It is well known to use radio-frequency identification (RFID) chips (also called RFID tags) to identify and track objects. In simple terms, an RFID chip comprises an integrated circuit with a read-only memory (ROM), plus an antenna for receiving an RF data signal, whereby selected data can be stored in the ROM, and for transmitting data stored in the ROM to a RFID chip reader (alternatively referred to as an interrogator).

Accordingly, data pertaining to a specific article can be stored in an RFID chip attached to the article, and then the data can be read by a suitable RFID chip reader. This technology has proven beneficial for inventory control and many other practical applications.

Some types of RFID chips incorporate a battery to enable data transmission without external power. In contrast, a passive RFID chip does not incorporate a battery, and requires power from an external source in order to transmit a data signal to an RFID chip reader. Although passive RFID chips typically have a shorter transmission range than battery-enabled RFID chips, they are typically much less expensive and can be made smaller than other RFID chips and therefore are desirable for many practical applications.

Normally, in order to read a passive RFID chip, an RFID chip reader transmits power to the passive RFID chip by means of inductive coupling of the reader's antenna and the RFID chip's antenna. The RF power from the reader antenna energizes the RFID chip, which then transmits its stored information back to the RFID chip reader, thus enabling passive RFID communication.

There are many known types of RFID chip readers. One common type is a hand-held RFID chip reader having a built-in antenna. This type of reader is normally used by passing it over a passive RFID chip such that the antenna can transfer power to the chip and then receive the resultant data transmission from the RFID chip, by means of radio frequency waves in both cases. The antenna of a typical hand-held RFID chip reader has an effective area much greater than that of a typical RFID chip. This fact does not hinder the reader's effectiveness in reading the RFID chip so long as the chip is not too small relative to the size of the reader's antenna, and so long as the RFID chip is not embedded in or attached to an article made from or containing a significant amount of a material that may interfere with electronic transmission of both power and data.

It has been found, for example, that if the receiving antenna of an RFID chip reader is quite large relative to the RFID chip antenna, or if the receiving antenna is small relative to the RFID chip, or if the RFID chip is embedded in a conductive metal such as steel or aluminum, the RF waves from the reader cannot energize the RFID chip, making it difficult or even impossible to read the chip. These problems are common with known, “off-the-shelf” types of RFID chip readers. However, it is highly desirable in many situations to minimize the size of RFID chips, and also to encase or embed RFID chips in metal objects to protect the chips from damage, as well as to facilitate inventory control for such items.

Accordingly, there is a need for means and methods for reading both small passive RFID chips and metal-embedded passive RFID chips. In particular, there is a need for means and methods for reading small passive RFID chips and metal-embedded passive RFID chips using known RFID chip readers, so that users will not necessarily have to acquire new RFID chip readers.

As noted above, it is often desirable to embed an RFID chip within the body of a product or other object, preferably such that the RFID chip lies fully below the exterior surface of the object, in order to protect the RFID chip from physical damage. The objects in question could be made from metal or other materials. It is known to insert an RFID chip into a chip-receiving pocket formed in such an object, but this has conventionally required the use of epoxies or other adhesives in order to ensure that the chip is securely and permanently attached to the object. This need to use adhesives results in higher costs for the process of embedding RFID chips in objects, as well as longer wait times before the objects in question are ready for use or shipping. Some known RFID chips intended for embedment in metal objects have been designed with the RFID chip and the chip holder being separate pieces (for example, the so-called “Crosby RFID plug”, manufactured by The Crosby® Group, Inc.), but this design increases costs because of the larger chip-receiving pocket required and also the additional cost of handling two separate pieces.

Accordingly, there is also a need for an improved type of RFID chip product that can be securely embedded or encapsulated in objects made from metal or other materials, without requiring adhesives. Preferably, such an improved RFID chip product would be of one-piece construction, thus avoiding certain disadvantages of the Crosby plug, as discussed above.

### BRIEF SUMMARY

The present disclosure addresses the foregoing problems by teaching, in one aspect, an antenna apparatus for use in conjunction with a conventional RFID chip reader, or for incorporation into an as-manufactured RFID chip reader. The antenna apparatus in accordance with the present disclosure comprises a primary antenna and a remote antenna, spaced apart but in electrical communication with each other. In one embodiment, the remote antenna is smaller than the primary antenna. Preferably, but not necessarily, the physical size of the remote antenna is close to that of an RFID chip intended to be read with the antenna apparatus. This facilitates optimally-effective power transfer and data transfer between the RFID reader and the RFID chip, particularly in cases where the RFID chip is mounted to or embedded in an electrically-conductive metal object, which would create interference with radio frequency wave transmission between the RFID reader and the RFID chip.

When it is desired to read data on a comparatively small RFID chip, the larger primary antenna is operatively engaged by the RFID chip reader while the smaller remote antenna is positioned in operatively-effective proximity to the RFID chip. However, when it is desired to read data on a comparatively large RFID chip, the smaller antenna is operatively engaged by the chip reader while the larger antenna is positioned in operatively-effective proximity to the RFID chip.

Accordingly, in one aspect the present disclosure teaches an RFID antenna apparatus comprising a primary antenna and a remote antenna in electronic communication with each other through connecting circuitry, such that data stored on an RFID chip can be transferred to an RFID reader by positioning the primary antenna in operatively-effective proximity to the RFID reader and positioning the remote antenna in operatively-effective proximity to the RFID chip.

RFID antenna apparatus in accordance with the present disclosure may be provided as a separate unit, thereby facilitating use with conventional RFID readers. In alternative embodiments, however, RFID antenna apparatus in accordance with the present disclosure may be incorporated into an RFID reader during initial manufacture.

Preferred embodiments of the RFID antenna apparatus may incorporate tuner means associated with the electronic circuitry connecting the primary and remote antennas, for optimization of circuitry effectiveness. When provided, the tuner means may be of any functionally suitable type within the knowledge and capabilities of persons skilled in the art to select or devise. However, it is to be understood that the provision of tuner means optional and not essential, and that alternative embodiments of the antenna apparatus not having tuner means are intended to come within the scope of the present disclosure.

In a second aspect, the present disclosure teaches an embedded or encapsulated RFID chip (alternatively referred to as an “RFID plug”) that can be securely and, for all practical purposes, permanently mounted or affixed to an object without use of adhesives, and without need for special tools. The RFID plug comprises an RFID chip encased within a preferably solid matrix of suitable plastic or other material that will not significantly impede or interfere with transmission of radio frequency signals, thus allowing the RFID chip to be read by an RFID chip reader even though the chip is encased. In illustrated embodiments, the RFID plug is of a disc-like cylindrical shape (somewhat suggestive of a tiny hockey puck), but having a plurality of rib-like ribs projecting radially outward from the cylindrical outer surface of the RFID plug. The shape and configuration of the ribs may vary in different embodiments of the RFID plug.

Although the RFID plugs will preferably be of generally cylindrical configuration as described above and as illustrated in the drawings, in alternative embodiments the

RFID plugs could be generally of rectilinear, ovate, or other geometric configuration without departing from the teachings of the present disclosure.

### BRIEF DESCRIPTION OF THE DRAWINGS

Embodiments in accordance with the present disclosure will now be described with reference to the accompanying Figures, in which numerical references denote like parts, and in which:

FIG. 1 conceptually illustrates the operation of a conventional prior art RFID chip reader.

FIG. 2 conceptually illustrates difficulties reading small or metal-encased passive RFID chips using conventional prior art RFID chip readers.

FIG. 3 is a schematic diagram of a first embodiment of an antenna apparatus for use with a passive RFID chip reader in accordance with the present disclosure.

FIG. 4 schematically illustrates the operation of a passive RFID chip reader antenna apparatus as in FIG. 3, being used to read a small or metal-encased passive RFID chip.

FIG. 5 is a schematic diagram of second embodiment of an antenna apparatus for use with a passive RFID chip reader in accordance with the present disclosure, shown in use to read a comparatively large passive RFID chip.

FIG. 6 is a top plan view of a first embodiment of an RFID plug in accordance with the present disclosure.

FIG. 7 is a bottom plan view of the RFID plug in FIG. 6.

FIG. 8 is an isometric view of the RFID plug in FIG. 6.

FIG. 9 is a side view of the RFID plug in FIG. 6.

FIG. 10 is a cross-section through an RFID plug as in FIG. 6, shown in position for insertion into a plug-receiving pocket in an object.

FIG. 10A is a perspective view of the RFID plug in position for insertion into a plug-receiving pocket as in FIG. 10.

FIG. 11 is a cross-section through an RFID plug as in FIGS. 10 and 10A, after being inserted into a plug-receiving pocket in an object.

FIG. 11A is a perspective view of the RFID plug after insertion into a plug-receiving pocket as in FIG. 11.

FIG. 12 is an isometric view of a second embodiment of an RFID plug in accordance with the present disclosure.

FIG. 13 is a side view of the RFID plug in FIG. 12.

FIG. 14 is an isometric view of a third embodiment of an RFID plug in accordance with the present disclosure.

FIG. 15 is a side view of the RFID plug in FIG. 14.

### DETAILED DESCRIPTION OF PREFERRED EMBODIMENTS

### Antenna for Passive RFID Chip Reader

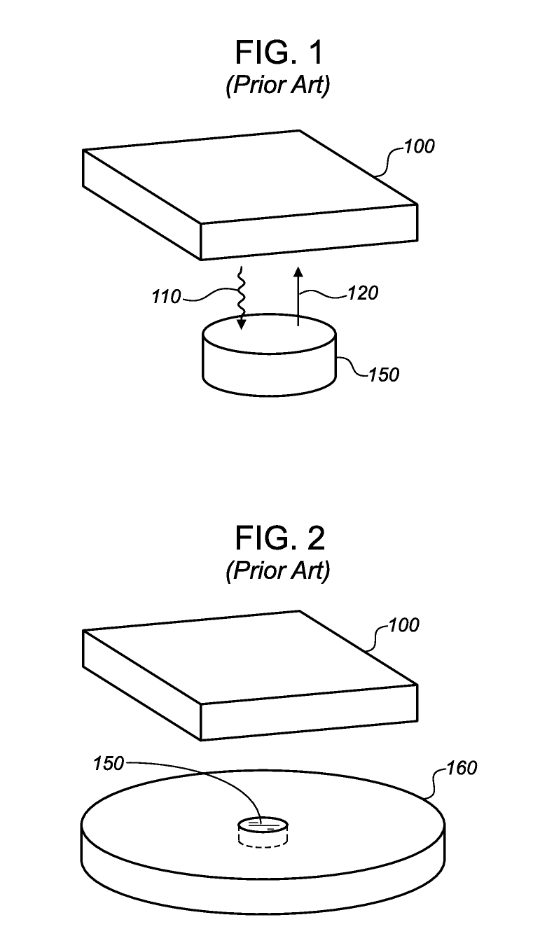

FIG. 1 conceptually illustrates the function and operation of a prior art RFID chip reader 100 being used to read data stored on a passive RFID chip 150. Although illustrated as being of puck-like physical configuration, RFID chips are typically quite thin. RFID chip reader 100, which is connected to a source of electrical power, wireless energizes passive RFID chip 150 as conceptually represented by power transmission arrows 110, whereupon chip 150 wirelessly transmits data to reader 100 as conceptually represented by data transmission arrows 120.

FIG. 2 conceptually illustrates a problem with known RFID chip readers when reading data on a comparatively small passive RFID chip 150, or when reading an RFID chip 150 mounted on or in an object 160 that is appreciably larger than chip 150, particularly if chip 150 is mounted to or in an object made of a material (e.g., a metallic substance) that can induce electrical interference impeding data transfer from RFID chip 150 to reader 100.

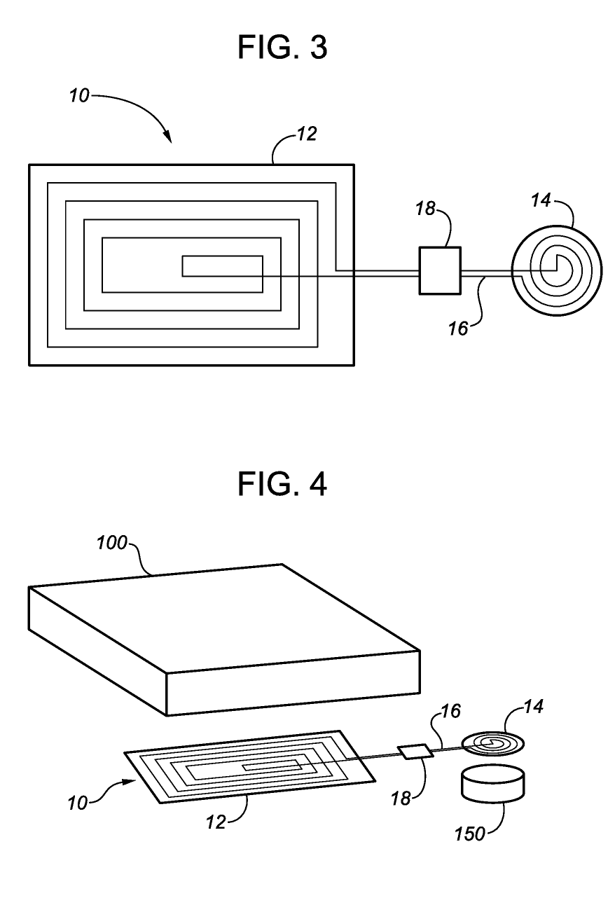

FIG. 3 schematically illustrates antenna apparatus 10 for use with, or incorporated in, a passive RFID chip reader in accordance with one embodiment of the present disclosure. FIG. 4 schematically illustrates antenna apparatus 10 as in FIG. 3 positioned in association with a passive RFID chip reader 100. Antenna apparatus 10 comprises a first antenna 12 (alternatively referred to as primary antenna 12) in electronic communication with a second antenna 14 (alternatively referred to as remote antenna 14) via connecting circuitry 16. In the illustrated embodiment, primary antenna 12 and remote antenna 14 each comprise a coil of electrically-conductive wire. In alternative embodiments, however, either or both of primary antenna 12 and remote antenna 14 could be any of various other known types of antennas, such as but not limited to loop antennas, squiggle antennas, and box antennas. The particular type of antenna used for purposes of primary antenna 12 and remote antenna 14 will be a design choice based on design and operational criteria and parameters such as but not limited to frequency.

In one preferred embodiment, connecting circuitry 16 will be simple passive connecting circuitry of any suitable known type, but the present disclosure is not limited to this or any other particular type of connecting circuitry 16.

In the embodiment shown in FIGS. 3 and 4, remote antenna 14 is smaller in physical size than primary antenna 12, and therefore is particularly well adapted for effective reading of a smaller RFID chip 150, and particularly so for an RFID chip 150 embedded in or otherwise associated with a metallic item (not shown in FIG. 4). Primary antenna 12 may be a component physically separate from RFID chip reader 100 (as shown in FIG. 4), or alternatively may be physically incorporated into chip reader 100. In the illustrated embodiment, connecting circuitry 16 incorporates optional tuner means 18 in accordance with technology known to persons skilled in the art. Tuner means 18 may be disposed anywhere along connecting circuitry 16, or incorporated into chip reader 100, but by way of alternative example only is shown electronically in-line with connecting circuitry 16. Primary antenna 12 is preferably but not necessarily larger than remote antenna 14, as seen in FIG. 3.

When provided as a separate component, antenna apparatus 10 can be used with conventional RFID chip readers, as conceptually illustrated in FIG. 4. In an unillustrated alternative embodiment, however, antenna apparatus 10 can be incorporated into a manufactured RFID chip reader, with primary antenna 12 being incorporated into the RFID chip reader and with remote antenna 14 separated from the main body of the RFID chip reader, but in electronic communication with primary antenna 12 by means of circuitry 16. RFID chips in accordance with such alternative embodiments can then be conveniently used to read RFID chips directly by means of primary antenna 12, or alternatively, in situations as previously discussed where effective reading of an RFID chip may be advantageously facilitated or enabled by use of smaller remote antenna 14, such as when the RFID chip to be read is mounted to or in a conductive metal object.

As schematically illustrated in FIG. 4, RFID chip reader 100 enables the use of a comparatively large primary antenna 12 for direct reading of both small and large RFID chips, and, by means of smaller remote antenna 14, to read RFID chips embedded in electrically-conductive metal, whereas most known RFID chip readers cannot effectively read small RFID chips or RFID chips embedded in electrically-conductive metal. To use a conventional RFID chip reader 100 to read an RFID chip 150 in conjunction with a separate antenna apparatus 10 as in FIGS. 3 and 4, primary antenna 12 of antenna apparatus 10 is positioned in the electric field of RFID chip reader 100, while at the same time positioning remote antenna 14 near RFID chip 150. RFID chip reader 100 inductively couples to primary antenna 12, and remote antenna 14 inductively couples to RFID chip 150. Electrical power is transmitted from RFID chip reader 100 to RFID chip 150 via primary antenna 12, connecting circuitry 16, and remote antenna 14, thereby enabling electronic transmission of data from RFID chip 150 to RFID chip reader 100 via remote antenna 14, connecting circuitry 16, and primary antenna 12 in sequence.

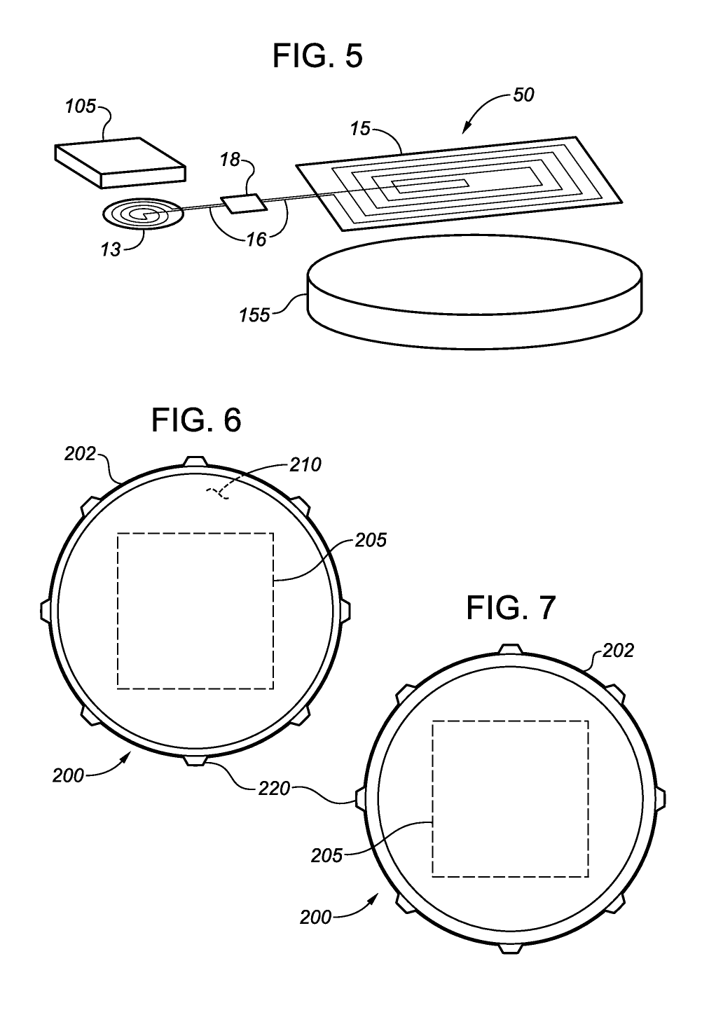

FIG. 5 schematically illustrates an antenna apparatus 50 in accordance with an alternative embodiment particularly adapted for use in conjunction with a comparatively small RFID chip reader 105 and a comparatively large RFID chip 155. Antenna apparatus 50 incorporates a smaller primary antenna 13 and a comparatively large remote antenna 15 for reading a comparatively large RFID chip 155. In this arrangement, larger remote antenna 15 is used to read data electronically transmitted by RFID chip 155, while smaller primary antenna 13 communicates the data read by remote antenna 15 to RFID chip reader 105. In an unillustrated alternative embodiment, smaller primary antenna 13 may be incorporated into a manufactured RFID chip reader, and with larger remote antenna 15 separated from the main body of the RFID chip reader, but in electronic communication with smaller remote antenna 14 by means of circuitry 16.

In FIGS. 3 and 4, primary antenna 12 is shown having a rectilinear configuration, and remote antenna 14 is shown as having a circular configuration, and in FIG. 5, primary antenna 13 is shown having a circular configuration, and remote antenna 15 is shown as having a rectilinear configuration. However, these configurations are by way of exemplary illustration only; primary antennae 12 and 13 and remote antennae 14 and 15 are not limited to any particular shape or physical configuration. Although primary antenna 12 of antenna apparatus 10 is shown to be significantly larger in size than remote antenna 14 and, similarly, primary antenna 13 of antenna apparatus 50 is shown to be significantly smaller than remote antenna 15, it is to be understood that the present disclosure is not limited to embodiments in which the primary and remote antennas are of different sizes.

In unillustrated alternative embodiments, the primary and remote antennas may be of substantially similar physical sizes. Similarly, both primary and remote antennas in accordance with the present disclosure can be of any size and geometric shape, and they do not have to be different from each other.

Having regard to the preceding disclosure, it will be readily appreciated that antenna apparatus 10 may be effectively used in conjunction with a conventional RFID chip reader 100 to read both small and metal-embedded RFID chips. For example, antenna apparatus 10 in accordance with the present disclosure can be mounted to or, alternatively, disposed in electrically-communicative proximity to a conventional RFID chip reader 100, with primary antenna 12 disposed adjacent to the integral antenna of RFID chip reader 100, with remote antenna 14 being located at the end of a suitable electrically-conductive extension element projecting from the main body of the reader, thus facilitating positioning of remote antenna 14 in electronically-communicative proximity to an RFID chip 150 desired to be read.

As an alternative to using antenna apparatus 10 in conjunction with a conventional RFID chip reader 100 as in FIGS. 3 and 4, it is also readily possible to manufacture an RFID chip reader that incorporates antenna apparatus 10, or to retrofit a conventional RFID chip reader to incorporate antenna apparatus 10, with remote antenna 14 effectively serving as or replacing the RFID chip reader's built-in antenna. Similarly, it is also readily possible to manufacture an RFID chip reader that effectively incorporates alternative antenna apparatus 50, or to retrofit a conventional RFID chip reader to incorporate antenna apparatus 50, with remote antenna 15 effectively serving as or replacing the RFID chip reader's built-in antenna.

### Embedded RFID Chips

RFID antenna apparatus 10 and 50 in accordance with the present disclosure can significantly enhance the utility and benefits of passive RFID chips, and especially smaller passive RFID chips, which can be more readily embedded in objects to be tracked using RFID technology. For various reasons previously discussed herein, however, there is also a need for an improved type of RFID chip product that can be securely embedded or encapsulated in both conductive and non-conductive metallic objects or, alternatively, objects made from other materials, without requiring adhesives.

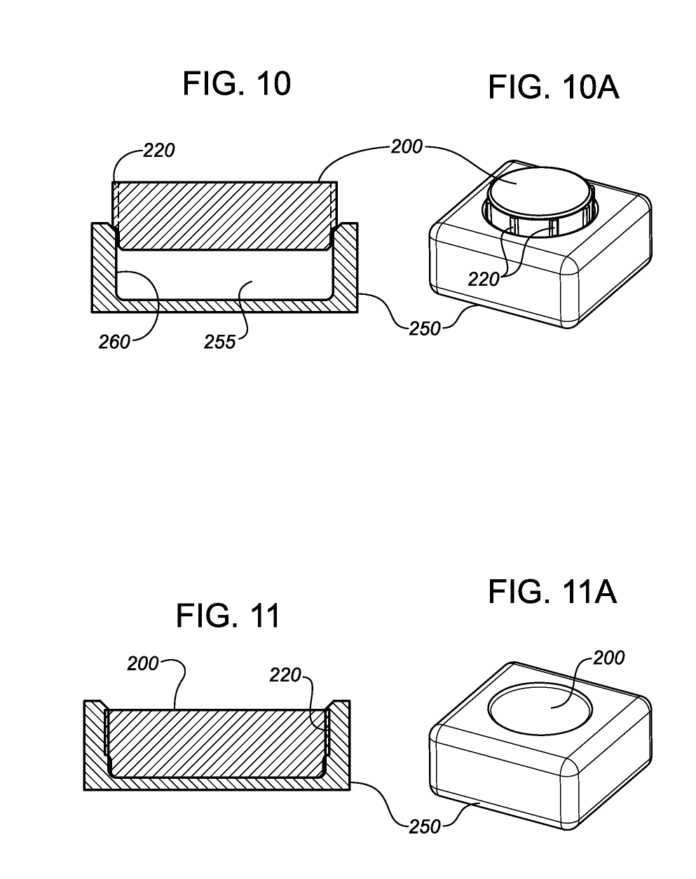

This need is met by embedded RFID chips in accordance with the present teachings. As used in this disclosure, the term “embedded RFID chip” is to be understood as including RFID chips completely encapsulated within a mass of another material, as well as RFID chips physically embedded in a mass of material but partly exposed. FIGS. 6 to 9 illustrate the construction of one embodiment of an RFID plug 200 in accordance with the present disclosure, and FIGS. 10, 10A, 11, and 11A illustrate how embedded RFID chips in accordance with the present disclosure can be embedded or otherwise effectively permanently installed in a object without the use of adhesives.

FIGS. 6, 7, 8, and 9 are, respectively, top, bottom, isometric, and side views of a first embodiment of an RFID plug 200 incorporating an RFID plug in accordance with the present teachings. FIGS. 10 and 10A are sectional and isometric views of RFID plug 200, shown in an initial position preparatory to effectively permanent installation in a plug-receiving pocket 255 formed in an object 250. In FIGS. 10 and 10A, object 250 is shown as a simple rectilinear block, but this is merely a convenient representational depiction; the actual configuration of an object 250 into which RFID plug 200 can be installed is for all practical purposes unrestricted.

In the embodiment shown in FIGS. 6-10 and 10A, RFID plug 200 and plug-receiving pocket 255 are of generally cylindrical configuration, with embedded RFID plug 200 comprising an RFID chip 205 embedded in a matrix 210 of non-electrically-conductive material such as but not necessarily limited to a plastic. RFID plug 200 incorporates a plurality of vertical ribs 220 distributed around and projecting radially outward from the perimeter side surface 202 of RFID plug 200.

In preferred embodiments, ribs 220 are made from a suitably deformable material, such as but not limited to a plastic, with at least a portion of the radially-outward surfaces of ribs 220 defining a circumferential diameter suitably less than the diameter of pocket 255 such that RFID plug 200 can be press-fit into pocket 255, and so as to be for all practical purposes unremovable from pocket 255. To facilitate installation of RFID plug 240 in a plug-receiving pocket 255 in an object 250, ribs 220 (and, most conveniently, RFID plug 200 as a whole) may be made from a plastic or other deformable material that is equally deformable, more readily deformable, or less readily deformable than the material from which object 250 is made. For example, the relative deformabilities of ribs 220 and the material used for object 250 may be selected such that insertion of RFID plug 200 into pocket 255 will result in: localized plastic deformation in ribs 220 only (e.g., when the material used for ribs 220 is significantly softer than the material of object 250); localized plastic deformation of perimeter wall 260 of pocket 255 only (e.g., when the material used for object 250 is significantly softer than the material of ribs 220); or localized plastic deformation of both ribs 220 and perimeter wall 260 of pocket 255.

Although RFID plug 200 and plug-receiving pocket 255 will preferably and perhaps most conveniently be of generally cylindrical configuration, RFID plug 200 and pocket 255 may be of a different geometric configuration (such as but not limited to oval and rectilinear) without departing from the scope of the present disclosure.

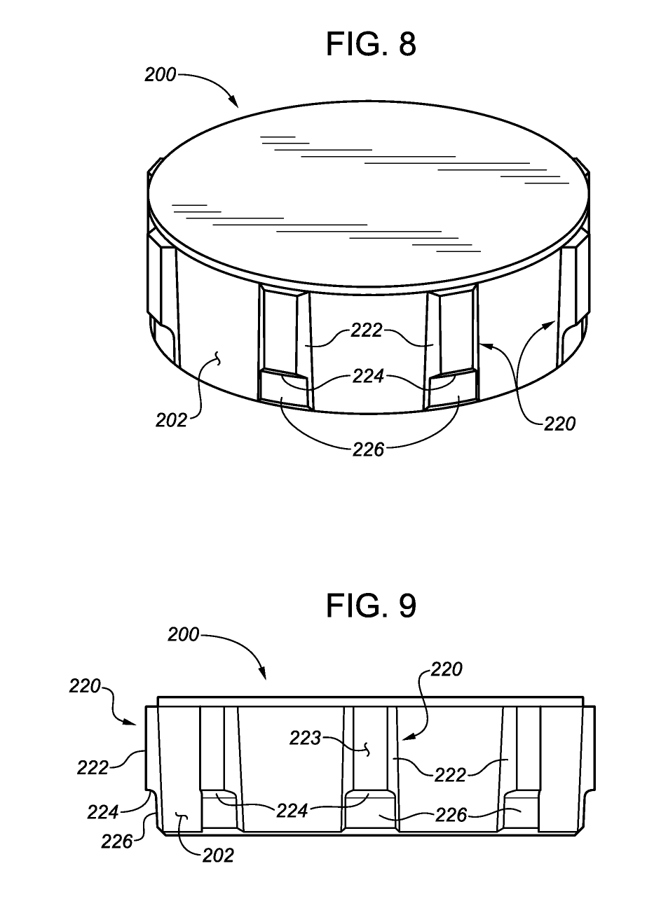

In the embodiment illustrated in FIGS. 8, 9, 10, 10A, 11, and 11A, each rib 220 has an upper section 222 configured such that the outer surfaces 223 of all upper portions 222 lie on a circle having a diameter larger than the diameter of pocket 255. Each rib 220 also has a lower section 226 configured such that the outer surfaces 227 of all lower portions 226 lie on a circle having a diameter less than or substantially equal to the diameter of pocket 255, with each upper portion 222 and lower portion 226 being separated by a transition section 224. As may be best appreciated with reference to FIGS. 10, 10A, 11, and 11A, this particular configuration facilitates installation of RFID plug 200 into plug-receiving pocket 255.

The first step in the installation process is to position RFID plug 200 as shown in FIGS. 10 and 10A, with lower portions 226 of ribs 220 disposed within plug-receiving pocket 255, and with transition sections 224 being supported on the perimeter edge of pocket 255. A downward force can then be applied against RFID plug 200 by any suitable means to press RFID plug 200 into pocket 255, preferably but not necessarily with the upper surface of RFID plug 200 disposed slightly below the surface of object 250, as shown in FIGS. 11 and 11A. Upper portions 222 of ribs 220 resiliently deform as RFID plug 200 is press-fit into pocket 255. This resilient deformation of ribs 220 creates outwardly-acting forces exerted against the cylindrical wall of the chip-receiving pocket, thereby reliably securing RFID plug 200 in pocket pocket 255 without need for adhesives, and making it difficult or impossible to remove RFID plug 200 without damaging or destroying it.

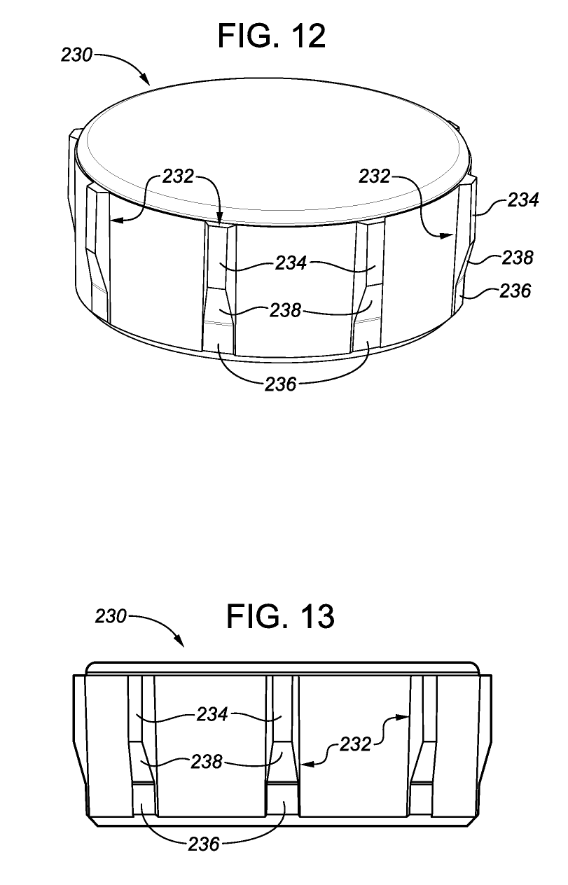

FIGS. 12 and 13 illustrate an alternative RFID plug embodiment 230, having radially-projecting ribs 232 with upper portions 234 and lower portions 236 separated by distinctly beveled transition sections 238. RFID plug 230 is thus largely similar to RFID plug 200 except that the beveled transition sections 238 of RFID plug 230 facilitate deformation of upper portions 234 of ribs 232 as RFID plug 230 is pressed into a plug-receiving pocket 255 in an object 250.

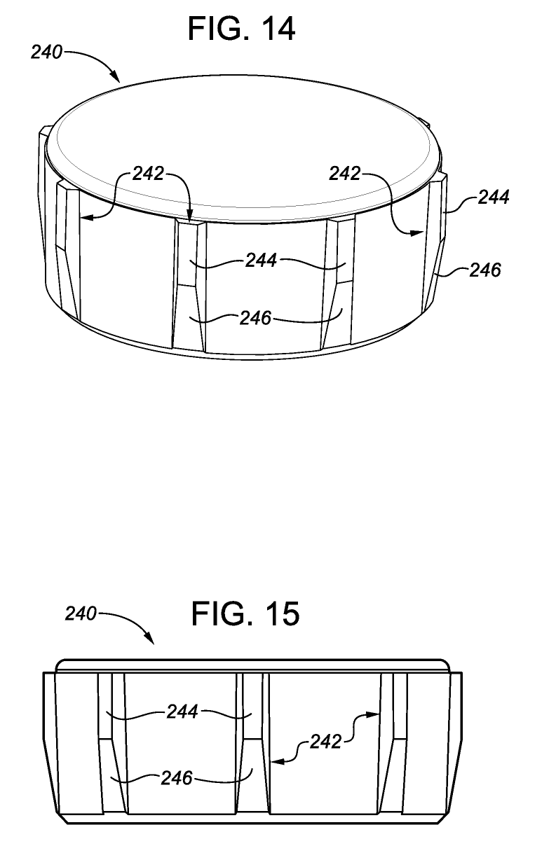

FIGS. 14 and 15 illustrate another alternative RFID plug embodiment 240 of an RFID plug in accordance with the present disclosure. In this embodiment, each rib 242 of RFID plug 240 has an upper portion 244 which transitions to a comparatively steeply beveled lower portion 246 extending down to the bottom of RFID plug 240. The steeper bevel of lower portions 246 of RFID plug 240, thus facilitating deformation of upper portions 244 of ribs 242 as RFID plug 240 is press-fit into a plug-receiving pocket 255 in an object 250.

It will be appreciated that ribs 220, 232, and 242 in the illustrated RFID plug embodiments provide different features which can be beneficially advantageous for the purpose of installing RFID plugs into a plug-receiving pocket and effecting secure retention therein. In addition to their functional usefulness, ribs of the illustrated configurations can also be considered ornamental.

It will be appreciated by persons skilled in the art that RFID plugs in accordance with the present disclosure may incorporate ribs having configurations different from the exemplary embodiments illustrated herein, without departing from the intended scope of the present disclosure. Moreover, and as previously stated, it will be understood that although all illustrated RFID plug embodiments are of generally cylindrical configuration, this is by way of example only, and the present disclosure is not limited to RFID plugs of the illustrated or any other particular geometric configurations.

In the illustrated embodiments, the ribs of the RFID plug are vertically oriented. However, this is not essential, and in alternative embodiments the ribs could be of horizontal, skewed, or other orientations without departing from the scope of the present disclosure. In fact, it is not essential that RFID plugs in accordance with the present disclosure have ribs as such, but could instead be provided with either deformable or non-deformable protuberances of any configuration provided that they are effective to facilitate, for all practical purposes, permanent embedment in a chip-receiving pocket. For example, RFID plugs in accordance with the present disclosure could be provided with pocket-engaging protuberances in the form of raised nubs or button-like elements. As well, it is to be understood that a given RFID plug could incorporate ribs or protuberances of different configurations. In summary, the pocket-engaging ribs or protuberances illustrated and/or described herein are exemplary only, and the present disclosure is intended to cover RFID plugs having configurations additional to those illustrated or described herein.

It will be readily appreciated by persons skilled in the art that various alternative embodiments of RFID chip reader antennas and embedded RFID chips may be devised without departing from the scope and teaching of the present disclosure, including modifications that use equivalent structures or materials conceived or developed subsequent hereto. Accordingly, it is to be understood that the scope of the present disclosure is not intended to be limited to any particular described or illustrated embodiment or embodiments, and that the substitution of a variant of a claimed element or feature, without any substantial resultant change of functionality, will not constitute a departure from the scope of the disclosure. It is also to be appreciated that the different teachings of the embodiments described and illustrated herein may be employed separately or in any suitable combination to produce desired results.

In this patent document, any form of the word “comprise” is to be understood in its non-limiting sense to mean that any item following such word is included, but items not specifically mentioned are not excluded. A reference to an element by the indefinite article “a” does not exclude the possibility that more than one of the element is present, unless the context clearly requires that there be one and only one such element. Any form of the word “typical” is to be understood in the non-limiting sense of “common” or “usual”, and not as suggesting essentiality. Any use of any form of the terms “connect”, “engage”, “couple”, “attach”, or any other term describing an interaction between elements is not intended to limit the interaction to direct interaction between the subject elements, and may also include indirect interaction between the elements such as through remote or intermediary structure. Relational and geometric terms such as “parallel”, “perpendicular”, “coincident”, “intersecting”, “circular”, and “cylindrical” are not intended to denote or require absolute geometric precision. Accordingly, such terms are to be understood as denoting or requiring only general relational or geometric conformance unless the context clearly requires otherwise.

What is claimed is:

1. An RFID antenna apparatus comprising a primary antenna and a remote antenna in electronic communication with each other through connecting circuitry, such that data stored on an RFID chip can be transferred to an RFID reader by positioning the primary antenna in operatively-effective proximity to the RFID reader and positioning the remote antenna in operatively-effective proximity to the RFID chip.

2. An RFID antenna apparatus as in claim 1, further comprising tuner means associated with the connecting circuitry.

3. An RFID antenna apparatus as in claim 1 wherein the primary and remote antennas each comprise a coil of electrically-conductive wire.

4. An RFID antenna apparatus as in claim 1 wherein the remote antenna is smaller than the primary antenna.

5. An RFID antenna apparatus as in claim 1 wherein the remote antenna is larger than the primary antenna.

6. An RFID reader comprising an RFID antenna apparatus in accordance with claim 1, wherein the primary antenna of the RFID antenna apparatus is incorporated into the RFID reader.

7. An RFID plug comprising an RFID chip embedded in a non-electrically-conductive material, said RFID plug having a plurality of outwardly-projecting protuberances.

8. An RFID plug as in claim 7 wherein the RFID plug is of a generally cylindrical configuration, and wherein at least one of the outwardly-projecting protuberances is a radially-projecting vertical rib.

9. An RFID plug as in claim 8 wherein the radially-projecting rib has an upper section and a lower section separated by a transition section.

10. An RFID plug as in claim 9 wherein the outer surface of the upper section of the radially-projecting rib has an outer radius greater than the outer radius of the lower section.

11. An RFID plug as in claim 9 wherein the transition section defines a beveled surface extending between the outer surfaces of the upper and lower sections.

12. An RFID plug as in claim 8 wherein the radially-projecting rib has an upper section and a lower section, with said lower section defining a beveled surface extending from the outer surface of the upper section to the bottom of the RFID plug.

13. An RFID plug as in claim 7 wherein the RFID plug is of a generally rectilinear configuration, and has a plurality of outwardly-projecting protuberances.

14. An RFID plug as in claim 13 wherein at least one of the outwardly-projecting protuberances is a vertical rib having an upper section and a lower section separated by a transition section.

15. An RFID plug as in claim 14 wherein the outward projection of the outer surface of the upper section of the vertical rib from the main rectilinear body of the RFID plug is greater than the outward projection of the lower section.

16. An RFID plug as in claim 14 wherein transition section defines a beveled surface extending between the outer surfaces of the upper and lower sections of the vertical rib.

17. An RFID plug as in claim 16 wherein at least one of the outwardly-projecting ribs is a rib having an upper section and a lower section.

18. An RFID plug as in claim 17 wherein lower section of the rib defines a beveled surface extending from the outer surface of the upper section to the bottom of the RFID plug.

19. An RFID plug as in claim 7 wherein at least one of the outwardly-projecting protuberances is a button-like element.
